(19) United States
(12) Patent Application Publication
(10) Pub. No.: US 2007/0271613 A1
(43) Pub. Date: Nov. 22, 2007

(54) Method and Apparatus for Heuristic/Deterministic Finite Automata

(76) Inventor: James B. Joyce, Little Rock, AR (US)

Correspondence Address: THOMPSON COBURN, LLP, ONE US BANK PLAZA, SUITE 3500, ST LOUIS, MO, 63101, US

(21) Appl. No.: 11/464,772

(22) Filed: Aug. 15, 2006

Related U.S. Application Data
(60) Provisional application No. 60/773,820, filed on Feb. 16, 2006.

(51) Int. Cl. G06F 12/14

(52) U.S. Cl. 726/23

(57) ABSTRACT

One embodiment of the present invention is a method for processing data in a computer or computer communications network that includes the steps of analyzing data using at least a first Heuristic/Deterministic Finite Automata (H/DFA), to classify data based upon pre-programmed programmed classification values assigned to different possible input data and/or pre-trained or dynamically updated heuristic engine output, and to select data for further processing based upon the resultant classification values that the logically interconnected look-up tables and/or heuristic components output given the input data. This exemplary embodiment overcomes disadvantages of previous methods for providing access control list, firewall, intrusion detection, intrusion prevention, spam filtration, anti-spyware, anti-phishing, anti-virus, anti-trojan, anti-worm, other computer security, routing, and/or switching related functionality. Heuristic algorithms, or a combination of logically interconnected look-up tables and heuristic techniques can also implement the H/DFA functionality. There are significant advantages in speed and scalability.

### RELATED APPLICATION DATA

This application claims the benefit of U.S. Provisional Application No. 60/773,820, filed on Feb. 16, 2006.

### BACKGROUND OF INVENTION

This invention relates generally to computer network security methods and apparatus, and more particularly to access control list, firewall, intrusion detection, intrusion prevention, spam filtration, anti-spyware, anti-phishing, anti-virus, anti-trojan, anti-worm, and other computer security, routing, and switching related functionality.

Currently, the Internet is, for the most part, wide open. It is possible to send data from virtually any system on the Internet to any other system, provided that the destination system has not been blocked by a firewall, access control list, or other restrictive security mechanism. That being stated, however, current firewall and access control list implementations are limited by practical considerations on the number of rules or access control list entries that can be added before data throughput performance is degraded. This is, primarily, due to a combination of the temporal and logical natures of linear processing associated with firewall rules and access control list entries. As the number of firewall rules or access control list entries increases, data throughput performance is degraded at a level in direct relation to the number of rules or list entries added. It is often desirable to establish a connection to the Internet that has one or both of the following characteristics: limited connectivity with respect to Internet destination, and/or limited accessibility from other parts of the Internet. Given the previously mentioned problem with respect to linear processing, the very large number of networks and systems connected to the Internet, and the seemingly random manner in which Internet Protocol address space has been assigned to various countries and organizations over time, current firewall, access control list, and other security related technology implementations do not, in many cases, lend themselves to establishing adequate access controls while simultaneously permitting acceptable or adequate data throughput performance levels.

In many cases, when a computer network is connected to the Internet, it does not need to be accessible to or from the entire Internet. For example, hypothetically, an organization connects a network to the Internet in the United States, but has no need for international connectivity—i.e., it has no international customers and/or does not want international accessibility. Implementing access controls with current technology to achieve desired isolation would result in such a long list of rules or access control list entries that data throughput would be unacceptably slow, that is, if the rule or access control list would even load up on a, for example, firewall or router. Another example of desired connectivity limitation might be a defense network for which the only allowable connectivity is to or from specific allies of the nation setting up the network. Again, this set of access controls could, very possibly, make valid access to the network in question, unacceptably slow, or even impossible. To further define the issue, an organization might wish to establish an Internet presence such that their systems are only accessible from a certain, potentially large, number of other organizations with Internet connectivity. Again, the associated rule or access control list size would be problematic given current technological implementations.

It would therefore be desirable to provide methods and apparatus that can process or filter data, based upon extremely large sets of criteria, and that can perform these functions at much higher data throughput rates than are currently available through either commercial products or from the open source community. It is also desirable to provide an invention that can take advantage of multiple analysis methodologies in order to deliver a greater level of security than is currently available. It would further be desirable for this invention to address multiple areas of computer and computer network security. Additional desirable features include superior and intuitive mechanisms for administration, configuration, monitoring, auditing, reporting, and general usage of computer security devices. As well, this invention should be adaptable with respect to deployment, including software-based implementations, firmware-based mechanisms, hardware-based mechanisms, and combinations thereof.

### SUMMARY OF INVENTION

There is therefore provided, in one embodiment of the present invention, a method for processing data in a computer or computer communications network that includes the steps of analyzing data using at least a first Heuristic/Deterministic Finite Automata (H/DFA) to classify data based upon pre-programmed classification values and/or pre-trained or dynamically updated heuristic engine output, assigned to different possible input data, and to select data for further processing based upon the resultant classification values that the logically interconnected look-up tables, e.g., Finite State Machine(s) (FSM), and/or heuristic components output given the input data. This exemplary embodiment overcomes disadvantages of previous methods for providing access control list, firewall, intrusion detection, intrusion prevention, spam filtration, anti-spyware, anti-phishing, anti-virus, anti-trojan, anti-worm, and other computer security, routing, and switching related functionality. Heuristic algorithms or a combination of the logically interconnected look-up tables and heuristic techniques can implement the H/DFA functionality.

This exemplary embodiment of heuristic and/or logical access controls defines the methods and apparatus that will yield desired, yet previously unattainable, levels of both security and data throughput performance, and has the advantages that it can be far more scalable and significantly faster than other technologies currently available.

These are merely some of the innumerable aspects of the present invention and should not be deemed an all-inclusive listing of the innumerable aspects associated with the present invention. These and other aspects will become apparent to those skilled in the art in light of the following disclosure and accompanying drawings.

### BRIEF DESCRIPTION OF DRAWINGS

For a better understanding of the present invention, reference may be made to the accompanying drawings in which:

FIG. 1 is a high-level, easily readable (i.e. actual binary values [e.g. unsigned integers, ASCII values, binary, etc . . . ] are represented in English, IP Address Range Octet Format, et. al.) embodiment of a deterministic table of the present invention. Note that it is a compressed version of one possible embodiment of a fully populated 8-Bit “Country Filter” Table, as Rows 9, 11, 13, 17, and 20 each represent a consolidation of multiple IP Address Ranges;

FIG. 2 is a high-level block diagram one possible embodiment of the present invention illustrating the process flow of data with respect to a logically interconnected look-up tables;

FIG. 3 is a very high-level block diagram of one embodiment of a multiple look-up tables; and

FIG. 4 is one embodiment of a world map that could be used in a Graphical User Interface (GUI) to facilitate configuration of the logically connected look-up table(s). By extension, it could also illustrate a part of a Virtual Reality-based configuration interface.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details.

Additionally, the present invention contemplates that one or more of the various features of the present invention may be utilized alone or in combination with one or more of the other features of the present invention.

With respect to logical network or computer access controls, herein is described a Heuristic/Deterministic Finite Automata (H/DFA). The H/DFA can be implemented with either, or a combination of, logical, hereafter referred to as logically interconnected look-up tables, e.g., Finite State Machine (FSM), or heuristic programming mechanisms. Heuristic programming mechanisms, for the intents and purposes of this invention, are defined in U.S. Pat. No. 6,519,703, issued on Feb. 11, 2003 to Joyce.

One superior embodiment of logical rule or access control entry processing is to implement a tree-based table traversal structure, which effectively results in logarithmic temporal traversal, as opposed to linear temporal traversal, of rules or access control lists. Additionally, a heuristic approach can be used to define the list. For example, neural networks and/or logically interconnected look-up tables can be trained or programmed to block or accept data from extremely granularly defined regions of Internet space, to or from specific types of data services, to or from a combination of locations and services, or numerous other combinations of selection criteria.

Practically, given the current state of microprocessor and/or system technology, the tree-based structure will function more quickly than most current heuristic techniques. This is due to the fact that most current heuristic techniques rely upon the use of floating point mathematics. Tree-based table structures can currently be handled within a microprocessor itself; whereas, heuristic structures are often handled via coprocessors. To clarify with an example, with the Linux operating system, there is no support for floating point operations within the kernel. Logically interconnected look-up tables, e.g., FSMs, do not require floating point processing and can, therefore, run within kernel space; whereas, heuristic engines do require floating point support and, therefore, run within user space. This usually results in slower processing of heuristic analysis, as opposed to logically interconnected look-up tables, e.g., FSM, analysis. That is not to say that heuristic analysis is not practical; rather, its' uses should be well thought through and implemented. In one possible embodiment of this description of the H/DFA, the tree-based logical structure of the logically interconnected look-up tables is used to evaluate each data packet as it comes into an evaluation location, e.g., a computer network interface. A heuristic engine is used to evaluate, at least, the initial data packet associated with establishing a session or data stream. If both components (logically interconnected look-up tables and heuristic engine) agree upon the acceptance state of an initial data packet, for example, then the session or data stream is allowed to initiate. If either component rejects the subject data packet, then the packet is summarily rejected. If each successive data packet is found to be acceptable to the tree-based structure, then the session or flow is allowed to continue. It is also possible to implement similar analysis where each and every packet is required to undergo inspection from both H/DFA components. Alternatively, either of the components can be used alone for data inspection.

There are several keys to the usefulness and success of this invention. One embodiment should be capable of operating at, at least, line or wire speeds (i.e. OC-192/9.6 Gbps). It should be capable of filtering (e.g., blocking or accepting data packets due to, respectively, undesired or permissible IP address, service port, payload, etc . . . ) data with a 100% accuracy level without dropping data (i.e., packets). Additional benefits in other areas of cyber-security will be realized by correct implementation of this technology. For example, by implementing a “United States Only” filter in front of an Internet accessible (U.S. based) computer/network, it becomes impossible for non-U.S. based computers to communicate with, or for that matter even “see”, the protected device(s). One immediate benefit to this will be that incidences of unsolicited email offerings (i.e., spam) will dramatically decrease, as the majority of spam does originate from outside of the U.S. A significant national and industry-wide side benefit to this spam reduction will be that any spam that gets into the protected computer/network must have come from the U.S., and, consequently, U.S. based spammers will be significantly easier to track down. As spam is now illegal in the U.S., a spammer-tracer/reporting (STR) utility should be a part of an exemplary implementation of this invention. This STR utility could include (but not be limited to) programming that automates the process of running “Who is” queries, ARIN lookups, traceroutes, and other techniques towards discovered spam-propagating devices. A significant benefit to this will be that Law Enforcement Agencies will be able to utilize this technology to more efficiently, affordably, and effectively perform their duties. Another example would be a “NATO Only” filter for networks associated with NATO data traffic, yet desiring to be totally isolated from non-NATO nation scrutiny. Still another example would be to use a “Malicious Hacker” filter—one that has been granularly refined, over time via “blacklists” and/or feedback from H/DFA components (et al.), to reject traffic from nations, organizations, networks, systems, etc. known to support or promote malicious hacker activity. Other examples would be “DoD Only” filters, “U.S. Government Agency Only”, “Business Needs Only”, “Industry Sector Specific”, etc . . . . Furthermore, correct robust implementation of this invention at key locations throughout the Internet (i.e., Internet Exchange Points, Internet Service Providers, etc.) can reduce risks associated with Distributed Denial of Service attacks, and other malicious techniques, for all protected networks and systems.

Another significant improvement that this invention makes feasible, when compared to current filtering techniques, is that the H/DFA can function over the entire range of Internet Protocol address space (i.e., IPv4, IPv6, etc.) and can filter with as much granularity as is desired at any currently available data throughput rate. Research has indicated that software-based logically interconnected look-up tables, e.g., FSMs, configured for “U.S. Only” IP filtration can operate at roughly ten times the speed of the fastest current commercially available communication speed, OC-192/9.6 Gbps. Hardware-based implementations (i.e., FPGA, ASIC, etc.) will realize even greater data throughput filtration capabilities as available communications speeds increase in the future.

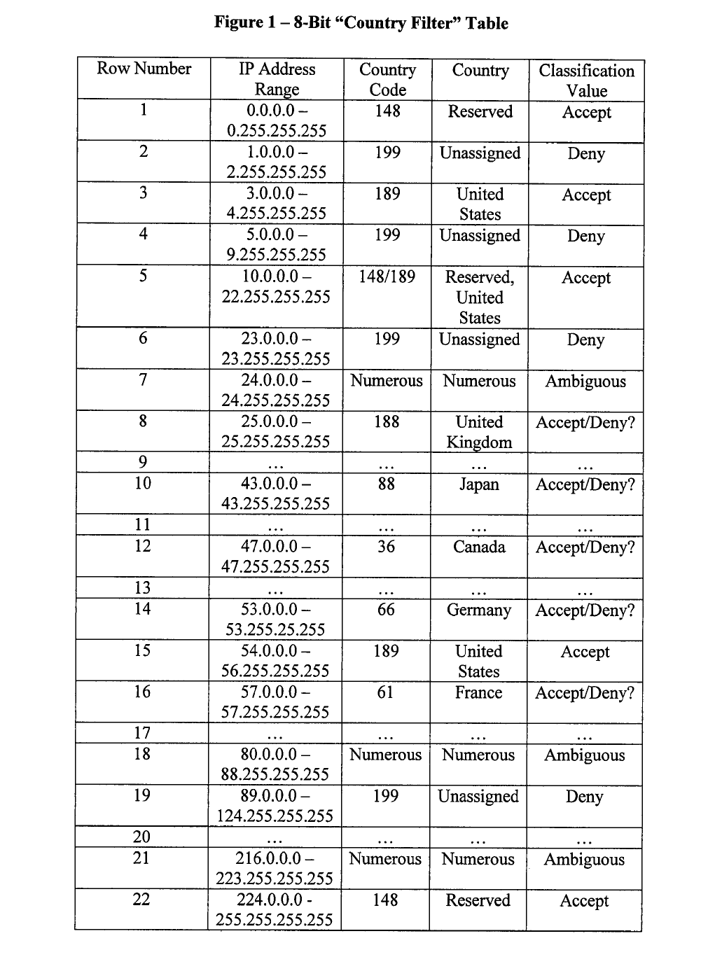

In one embodiment of the present invention specifically referring to the “Country Filter” Table in FIG. 1, a structure is provided that illustrates the concept of a logically interconnected look-up tables, e.g., Finite State Machine (FSM), to perform Access Control List (ACL) IP address filtering functionality. The “Row Number” column is included as a reference. This table, when given a 32-bit IP address as input, attempts to determine whether to “Accept” or “Deny” said data based solely upon an evaluation of the first 8 bits of the input IP address. The table has been created such that contiguous network ranges assigned to the same country (or category) and identical “Classification Value” are concatenated—examples of this can be found in Rows 2, 3, 4, 15, 19, 21, and 22. To further clarify, Row 2 contains the 1.0.0.0 and 2.0.0.0 networks, both network ranges are assigned to “Unassigned” (Country Code 199), and both have a “Classification Value” set to “Deny”. Additional optimization can be seen in Row 5 which is a combination of contiguous network ranges assigned to “Reserved” and “United States”, where all network ranges (from the 10.0.0.0 network through the 22.0.0.0 network) have “Classification Value” set to “Accept”. Rows 7, 18, and 21 exemplify network ranges that contain subdivisions assigned to various countries or categories, but the Classification Value cannot be uniquely defined or determined for the entire concatenated range, based upon (in the case of this specific table) an analysis of the first 8 bits of the IP address in question. The Classification Value of “Ambiguous” indicates that it will take more than 8 bits of the input IP address to determine if the data should be accepted or denied by the logically interconnected look-up tables.

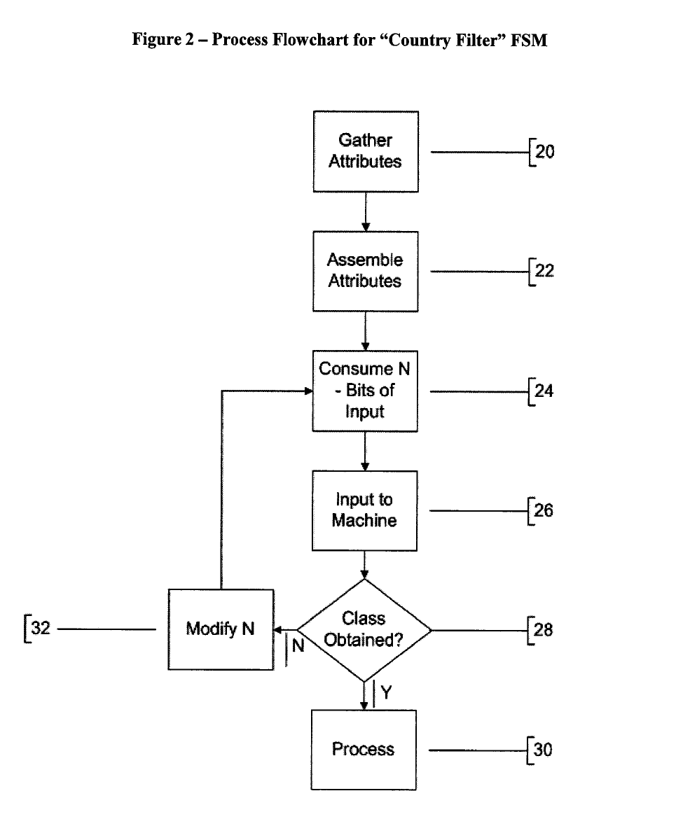

FIG. 2 illustrates a high-level Process Flowchart of one possible logically interconnected look-up tables, e.g., FSM, embodiment. For this example, the “Country Filter” logically interconnected look-up tables, IPv4 packets (though any structured protocol can be similarly processed) are collected for the logically interconnected look-up tables via the promiscuous interface 20. IP addresses (and/or other attributes) are acquired from the packets by process 22. To use the 8-Bit “Country Filter” Table [FIG. 1] as an example, at process 24, the first 8 bits of the 32-bit IP address 22 are pulled and sent to process 26. Process 26 results in a Classification Value output based upon comparison of 22 with FIG. 1. At 28, if the Classification Value was either Accept or Deny, process 30 initiates. If the Classification Value reports “Ambiguous” [i.e., FIG. 1, Rows 7, 18, 21], N is modified 32 and the value is returned to 24. 26 would then process with a different table (i.e., 9-Bit “Country Filter” Table). This continues until an unambiguous Classification Value is returned.

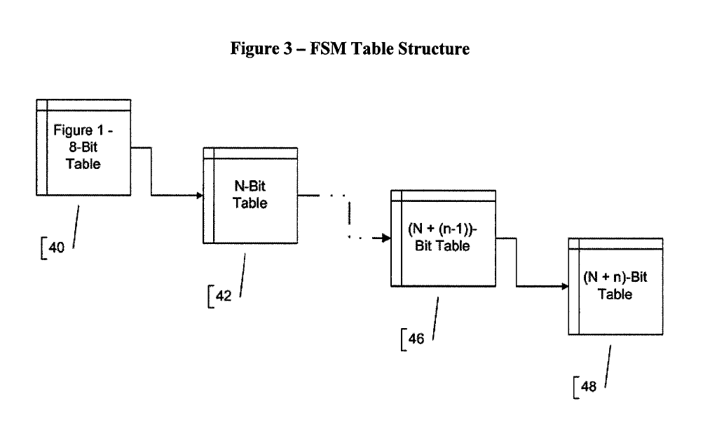

FIG. 3 illustrates a generalization of this process flow. To continue with the IPv4 example, 40 would represent FIG. 1, 42 would represent a 9-bit table, and in the worst cases 46 and 48 would represent 31-bit and 32-bit tables respectively. It should be intuitive that it is not necessary to increment N by only 1 bit per iteration. Also note that the tables need not be strictly serially structured. Proper structuring of table data and table interconnectivity yields logarithmic temporal traversal through deterministic processing, as opposed to the linear temporal traversal used in contemporary devices. By natural extension, the tables could equally be embodiments of the IPv6 address space, service ports, routing information, or, for that matter, any other grouping(s) of data that can be expressed contiguously, again, by extension, leading to logical combinations of logically interconnected look-up tables, e.g., FSMs, where each individual logically interconnected look-up table represents a finite contiguous space. A simple combinatorial example would be to combine logically interconnected look-up tables such as, but not limited to: IP address, service port, state, authentication, authorization, audit, string identifier tables via combinatorial logic and/or heuristics to yield a superior H/DFA-based firewall. The granularity, scalability, and throughput capabilities of this model far exceed the offerings currently available today, to the extent that the H/DFA can be programmed to look for specific payload detail in addition to traditional firewall “rules” information at wire or line speed.

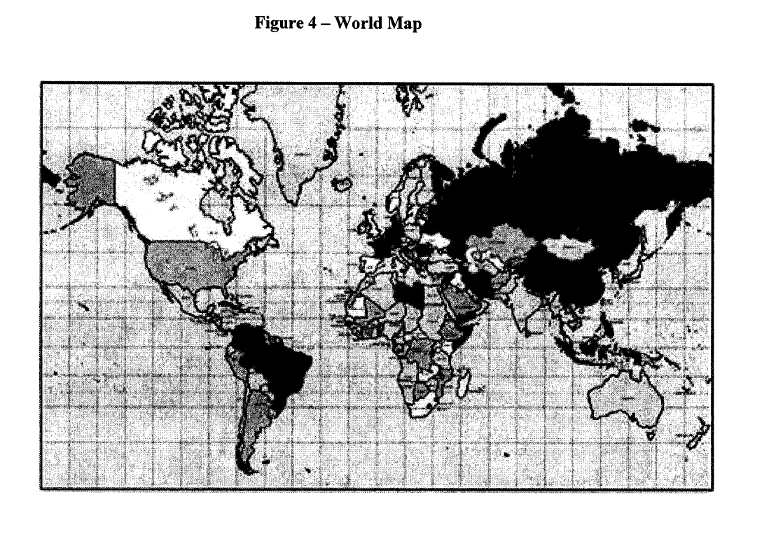

FIG. 4 illustrates a world map. A world map is suggested for integration into the Graphical User Interface (GUI) for this invention to be utilized for ease of configuration and administration purposes. If a system administrator had to manually enter tens of thousands of individual networks, and potentially billions of systems, into the configuration parameters of this invention, issues associated with human entry errors would degrade the effectiveness of this invention. As well, linear temporal traversal of such a configuration would bring data throughput to a crawl. In this embodiment, administrators can individually, or in a grouping fashion, select countries or region of the world upon which to apply encompassing “accept” or “deny” logic. Furthermore, it is possible to, for example, select individual countries or regions, apply (again, for example) “deny” to all networks and systems in said regions, and then to select desires networks or systems from the “deny” region from which data will be accepted, thereby “slotting out” granular access. A simple way to effect this functionality would be to program the map such that a single mouse click on a country selects that country for application of “global” accept or deny, then to apply the desired access. One could also program the map such that a double mouse click opens up a menu listing (with, for example, checkboxes) of all networks in that country. Additionally, for example, a utility can be implemented such that double clicking on an individual network or system from within this menu listing yields further information about the subject network/system (e.g., country of origin, company of origin, ISP, etc . . . ). From this menu listing, the administrator could select individual networks or systems that should have different access restrictions than the global policies that were set for the country of interest. One should also, by extension, then be able to graphically “drill down” into individual networks or systems and apply even more granular policies, access rules, requirements, service port limitations, anticipated or acceptable or prohibited payload strings, etc . . . . Once configuration parameters have been selected via the GUI, logically interconnected look-up tables and/or heuristic training data sets should be generated by the system.

By further extension, the functionality of the GUI can be implemented via a virtual reality interface through Virtual Reality Modeling Language (VRML), a VRML toolset, or some other VR development environment. To date, most VRML implementations have been associated with the computer gaming industry, military theatre simulations, flight simulators, and the like. Application of VRML to computer or network administration should realize numerous benefits including greater productivity, error minimization, and significant security enhancement by eliminating the threats associated with “shoulder surfing”—a process whereby someone either manually, or with the help of a camera (or similar device or technique), looks at a computer screen “over the shoulder” of another user. A robust VR interface for this invention should include, but not be limited to, a high-resolution heads-up display, motion tracking, and eye tracking equipment (such as those sold by NVIS Inc. Reston, Va., USA), VR gloves (such as those from VPL Research, Inc. Redwood City, Calif., USA), voice/speech interface (such as those from Nuance Communications, Inc. Burlington, Mass., USA), and other peripherals. Said interface should also function as a VR browser, akin to the numerous Internet browsers available today—a system user should be able to perform all computer usage through this VR interface. Via this technique, a system user could virtually place himself/herself inside of the system, network, or Internet in general. System utilities can be represented, as desired, by avatars that interact with the VR representation of the system user in a much more “personal” manner than traditional GUI or Command Line Interfaces currently allow. This personal interaction and improvement of the man-machine interface should result in higher productivity, a greater understanding of, and increased accuracy with respect to, for example, system administration tasks.

With respect to apparatus, the invention is not limited to particular computer hardware and/or software. It can be implemented on micro, mini, or mainframe hardware, as well as via Field Programmable Gate Array (FPGA) or Application Specific Integrated Circuit (ASIC) technology. It is also independent of any specific computer operating system, as this invention is compatible with numerous currently available operating systems. An exemplary version of this technology is implemented on a Pentium platform running a modified version of the Linux operating system. The heuristic components, in this case neural networks, are being developed through the use of NeuralWare, Inc. (Carnegie, Pa., USA) neural network development products.

It will thus be seen that embodiments of the present invention provide Heuristic/Deterministic Finite Automata (H/DFA) methods and apparatus that can be pre-programmed and/or that can learn from and adapt to data in order to mitigate a wide variety of computer and computer communication network (CCN) security threats. Multiple analysis methodologies are provided in some embodiments to facilitate enhanced security and usability, and provide the scalability, adaptability, and performance characteristics needed to adapt to the ever-evolving scope of security problems.

Although the invention has been described in terms of various specific embodiments relating to computer access control lists and firewalls, it will also be recognized that the invention is also applicable in numerous other security related products and areas of interest including, for example, data shunt devices, network simulation systems, biometric analysis and biometric anomaly analysis systems, security architecture designs, network operation centers, VPN systems, and security information management systems; therefore, those skilled in the art will recognize that the invention can be practiced with modification within the scope and spirit of the claims. The terms “have,” “having,” “includes,” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims that follow.

1. A method for processing data in a computer or computer communications network (CCN) comprising the steps of:
analyzing one or more attributes of a packet, packets, or other data structure(s) utilizing logically interconnected look-up tables that have been pre-programmed to assign classification values to each possible combination, or subset(s) of possible combinations, of input attributes;
assigning a classification value to each data structure, or combination of data structures, based upon the output of the plurality of logically interconnected look-up tables; and
selecting data structure(s) for further processing based upon the resultant classification values.

2. The method in accordance with claim 1, further includes utilizing a nonlinear time search algorithm.

3. The method in accordance with claim 2, wherein the nonlinear time search algorithm includes a logarithmic time search algorithm.

4. The method in accordance with claim 1, further includes assigning at least one of states, inputs, and classification values to the logically interconnected look-up tables prior to deployment into a computer or CCN.

5. The method in accordance with claim 1, further includes at least one of dynamically adding, dynamically deleting, and dynamically modifying at least one of a state, an input and a classification value to and from the logically interconnected look-up tables while being deployed in the computer or CCN.

6. The method in accordance with claim 1, further includes incrementally consuming one or more bits of data attributes and utilizing the one or more bits of data attributes to control the logically interconnected look-up tables.

7. The method in accordance with claim 1, further includes utilizing a plurality of logically interconnected look-up tables that are cascaded.

8. The method in accordance with claim 1, further includes utilizing a plurality of parallel logically interconnected look-up tables, wherein each logically interconnected look-up table processes differing subsets of data attributes, wherein the plurality of parallel logically interconnected look-up tables includes outputs that are utilized either independently and/or in combination to determine further data processing.

9. The method in accordance with claim 1, further includes analyzing the classification value(s) of data structure(s) and utilizing the analysis to shunt the data to other system(s) or subsystem(s) for further processing.

10. The method in accordance with claim 1, further includes analyzing the classification value(s) of data structure(s) and utilizing the analysis to assign quality of service (QoS) value(s) for further processing.

11. A method for processing data in a computer or computer communications network (CCN) comprising the steps of:
describing attribute(s) of the input data or attribute range(s) describing multiple datum; and
utilizing logically interconnected look-up tables to output the assigned classification value(s).

12. The method in accordance with claim 11, further includes integrating lists of Internet Protocol (IP) addresses assigned to countries or geographic regions into the logically interconnected look-up tables.

13. The method in accordance with claim 11, further includes integrating lists of companies, organizations, industry sectors, government agencies, computers, CCNs, devices, individuals, groups of individuals, or combinations of the aforementioned groupings into the logically interconnected look-up tables.

14. The method in accordance with claim 11, further includes integrating lists of known or discovered spam servers into the logically interconnected look-up tables.

15. The method in accordance with claim 11, further includes integrating lists of known or discovered malicious systems or devices into the logically interconnected look-up tables.

16. The method in accordance with claim 11, further includes integrating lists of malware signatures into the logically interconnected look-up tables.

17. The method in accordance with claim 16, wherein the malware is selected from the group consisting of a computer virus, a trojan, or a worm.

18. The method in accordance with claim 11, further includes integrating lists of known or discovered compromised computers or CCNs into the logically interconnected look-up tables.

19. The method in accordance with claim 11, further includes storing temporal information for utilization with the logically interconnected look-up tables.

20. A method for processing data in a computer or computer communications network (CCN) comprising the steps of:
analyzing one or more attributes of a packet, packets, or other data structure(s) utilizing at least one heuristic algorithm to assign classification values to each possible combination, or subset(s) of possible combinations, of input attributes;
assigning a classification value to each data structure, or combination of data structures, based upon the output of the at least one heuristic algorithm; and
selecting data structure(s) for further processing based upon the resultant classification values.

21. The method in accordance with claim 20, wherein the at least one heuristic algorithm is selected from the group consisting of an artificial neural network, a fuzzy logic algorithm or a genetic algorithm.

22. A method for processing data in a computer or computer communications network (CCN) comprising the steps of:
analyzing one or more attributes of a packet, packets, or other data structure(s) utilizing a combination of logically interconnected look-up tables and at least one heuristic algorithm to assign classification values to each possible combination, or subset(s) of possible combinations, of input attributes;
assigning a classification value to each data structure, or combination of data structures, based upon the output of the combination of logically interconnected look-up tables and at least one heuristic algorithm; and
selecting data structure(s) for further processing based upon the resultant classification values.

23. A method for processing data in a computer or computer communications network (CCN) comprising the steps of:
utilizing at least one of logically interconnected look-up tables and at least one heuristic algorithm to analyze data to determine at least one of an identity of a computer, a CCN, a computer network block, a computer user, a computer routine, a country of origin, a geographic location of origin, an Internet Service Provider (ISP) of origin, and an organization of origin.

24. The method in accordance with claim 23, wherein output of at least one of the logically interconnected look-up tables and at least one heuristic algorithm is dynamically updated or modified.

25. The method in accordance with claim 23, wherein output of at least one of the logically interconnected look-up tables and at least one heuristic algorithm generates at least one of an alert, an alarm, a report, a system log, or other message.

26. A method for processing data in a computer or computer communications network (CCN) comprising the steps of analyzing heuristic/deterministic finite automata output data utilizing at least one of a tool and a utility to perform security related functions selected from the group consisting of spam system identification, phishing system identification, or other malware system identification.

27. The method in accordance with claim 23, further includes at least one of redirecting or shunting identified data to a destination other than that which is contained within the data itself from the group consisting of a honeypot, an alternative analysis system, or another predetermined system, device, or network.

28. A method for processing data in a computer or computer communications network (CCN) comprising of utilizing a graphical user interface (GUI) which displays a map of the world, or other spatial region(s), for the purpose of selecting regions, areas, computers, and/or CCNs that are to be assigned specific classification values.

29. The method in accordance with claim 28, further includes utilizing the selected portions to generate at least one of a look-up table and a training set for a heuristic algorithm.

30. A method for processing data in a computer or computer communications network (CCN) comprising of utilizing virtual reality technology (VR) interface to perform at least one of the following functions including administering, configuring, and/or monitoring one or more data processing systems, computers, devices, CCNs, processes, and system users.
